(19) United States
(12) Patent Application Publication
(10) Pub. No.: US 2013/0228525 A1
(43) Pub. Date: Sep. 5, 2013

(54) TEMPERATURE SWITCHABLE POLYMERS FOR FINE COAL DEWATERING

(71) Applicant: THE GOVERNORS OF THE UNIVERSITY OF ALBERTA, (US)

(72) Inventors: Qingxia Liu, Edmonton (CA); David Yeung, Edmonton (CA); Zhenghe Xu, Edmonton (CA); Rajender Gupta, Edmonton (CA); Jacob Masliyah, Edmonton (CA)

(73) Assignee: THE GOVERNORS OF THE UNIVERSITY OF ALBERTA, Edmonton (CA)

(21) Appl. No.: 13/784,481

(22) Filed: Mar. 4, 2013

Related U.S. Application Data
(60) Provisional application No. 61/606,119, filed on Mar. 2, 2012.

(30) Foreign Application Priority Data
Mar. 2, 2012 (CA) 2770347

(51) Int. Cl. C08F 22/38; C02F 1/56

(52) U.S. Cl. CPC C08F 22/38; C02F 1/56
USPC 210/710; 525/296

(57) ABSTRACT

A flocculating agent that comprises a complex of a metal salt and multiple strands of a temperature sensitive polymer. A process for separating coal fines from an aqueous liquid using a flocculent having a critical flocculation temperature, said critical flocculation temperature being the temperature below which flocculent is hydrophilic and forms floccules with fines and above which the flocculent is hydrophobic, which comprises adding to the aqueous liquid an effective amount of the flocculent at a temperature below the critical flocculent flocculation temperature of the flocculent to cause generation of floccules, said comprising at least a metal complex including a metal salt and a water soluble polymer, separating (for example filtering) floccules from the aqueous liquid, then heating the floccules to a temperature above the critical flocculation temperature of the flocculent to expel water from the floccules to create a solids and expelled water, and separating the expelled water from the solids.

### CROSS-REFERENCE TO RELATED APPLICATIONS

This application claims the benefit under 35 USC 119(e) of U.S. provisional application Ser. No. 61/606,119 filed Mar. 2, 2012.

### FIELD

Fine coal dewatering.

### BACKGROUND

Coal is the world's most abundant fossil fuel resource, much larger than that of oil and gas. Effective processing of coal is thus desirable, but is challenging, especially regarding cost effective dewatering of coal fines. Removal of moisture from coal fines is significant due to the immense energy consumption for drying and negative impacts to the end product. These include lower calorific value, increased transportation cost, and problematic material handling. At one point, the fine coal streams were discarded before the value of this stream was recognized. Current practice recovers this stream utilizing chemical and filtration treatment, followed by thermal drying to reduce moisture levels to acceptable levels. All of these factors create a desire for a cost effective and competitive filtration method eliminating the usage of thermal driers.

In recent studies, there has been a large focus on chemical additions to the coal such as surfactants and polymers. Among these, a disadvantage of using polymers has typically been its hydrophilic nature entrapping water in floccules formed by the coal and polymer. The use of temperature sensitive polymer in dewatering applications has received an ever increasing interest in recent years due to its effective flocculation behavior and temperature dependent nature. The disclosed invention relates to improvements in use of temperature sensitive polymers in dewatering applications.

### SUMMARY

A flocculating agent that comprises a complex of a metal salt and multiple strands of a temperature sensitive polymer that has a critical temperature below which the temperature sensitive polymer is a flocculent and above which the temperature sensitive polymer is hydrophobic.

A process for separating coal fines from an aqueous liquid using a flocculent having a critical flocculation temperature, said critical flocculation temperature being the temperature below which flocculent is hydrophilic and forms floccules with fines and above which the flocculent is hydrophobic, which comprises adding to the aqueous liquid an effective amount of the flocculent at a temperature below the critical flocculent flocculation temperature of the flocculent to cause generation of floccules, said comprising at least a metal complex including a metal salt and a water soluble polymer, separating (for example filtering) floccules from the aqueous liquid, then heating the floccules to a temperature above the critical flocculation temperature of the flocculent to expel water from the floccules to create a solids and expelled water. The solids and expelled water can then be easily subject to further processing.

Other features are found in the detailed description and claims.

### BRIEF DESCRIPTION OF THE DRAWINGS

Embodiments will now be described with reference to the drawings, in which:

FIG. 1: Process of polymer addition to ultra-fine coal (a) Suspended ultra-fine coal particles (b) Temperature sensitive polymer addition to coal (c) Dewatered floccule of ultra-fine coal.

FIG. 2: Schematic showing Custom built filtration Press System

FIGS. 3A and 3B: Graphs showing the effect of polymer dosage on the filtration rate of ultra-fine coal at room temperature with (A) Poly [NIPAM-DMAPMA] and PAM (B) Al-Poly [NIPAM-DMAPMA] and PAM.

FIGS. 4A and 4B: Graphs showing the effect of polymer dosage on the moisture content of ultra-fine coal at room temperature with (A) Poly [NIPAM-DMAPMA] and PAM (B) Al-Poly [NIPAM-DMAPMA] and PAM.

FIGS. 5A and 5B: Graphs showing the effect cake heating as a function of polymer dosage on the moisture content of ultra-fine coal with (A) Poly [NIPAM-DMAPMA] and PAM (B) Al-Poly [NIPAM-DMAPMA] and PAM.

FIG. 6: Schematic showing a process of Al-Poly[NIPAM-DMAPMA] addition to ultra-fine coal that shows the (a) Unheated floccule (b) Heated floccule

FIG. 7: Graph showing a comparison between the contact angles of measured pellets as a function of temperature for various polymers.

FIG. 8: Graph showing a comparison between the surface tension as a function of dosage for various polymers.

FIG. 9 shows a trajectory of the described process during the filtration process, from cake formation, to cake filtration, capillary dewatering and mass transfer dewatering.

FIGS. 10A-C describe exemplary polymers. FIG. 10(a) shows polyacrylamide (PAM), FIG. 10(b) shows p[NIPAM-DMAPMA] and FIG. 10(c) shows p[Al-NIPAM-DMAPMA]

FIG. 11 shows experimental process steps.

### DETAILED DESCRIPTION

Temperature sensitive polymers are known, for example in U.S. Pat. No. 4,536,294, that exhibit the property of having a transition temperature below which the polymer is hydrophilic and forms floccules with fine solid particles in an aqueous solution and above which the polymer is hydrophobic and expels water from the floccule to create solids and expelled water. In one embodiment, there is disclosed a novel temperature sensitive flocculating agent that comprises a complex of a metal salt and multiple strands of temperature sensitive polymer. The temperature sensitive polymers may have molecular weight at least 0.5×10⁶ g/mol and a critical flocculation temperature in the approximate range 0° C. to 80° C. The polymers disclosed in U.S. Pat. No. 4,536,294 may be used as the disclosed temperature sensitive polymer.

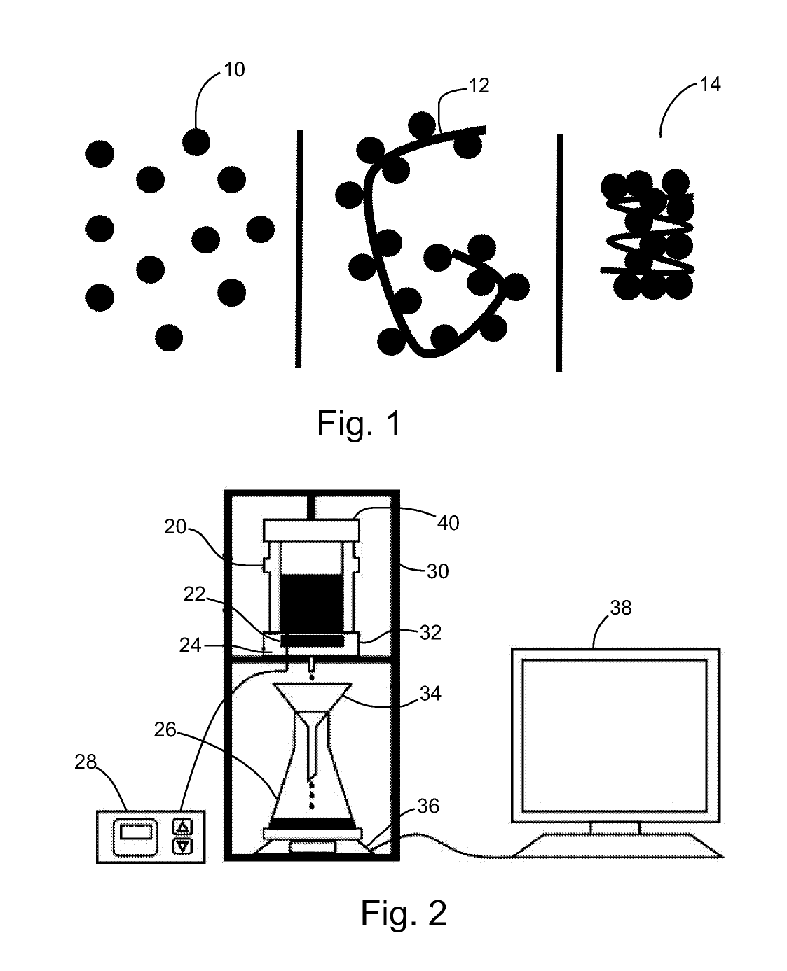

There is also disclosed a process for separating coal fines or other fines from an aqueous liquid using a temperature sensitive flocculating agent of for example molecular weight at least 0.5×10⁶ g/mol and which has a critical flocculation temperature in the approximate range 0° C. to 80° C., said critical flocculation temperature being the temperature below which the temperature sensitive flocculating agent exhibits flocculating ability and above which the temperature sensitive flocculating agent is hydrophobic, which comprises adding to the aqueous liquid an effective amount of the temperature sensitive flocculating agent at a temperature below the critical flocculation temperature of the flocculent (step a in FIG. 1) to cause generation of floccules (step b in FIG. 1), said flocculent comprising at least a metal complex including a metal salt and a water soluble polymer, separating (such as by filtering) floccules from the aqueous liquid, then heating the floccules to a temperature above the critical flocculation temperature of the temperature sensitive flocculating agent to expel water from the floccules to create solids and expelled water (step c in FIG. 1). Further processing may include separating the expelled water from the solids.

Further detail of process steps is found in FIG. 11. Water 50 is added to coal particles 52, and mixed for example by stirring such as magnetic stirring. Then temperature sensitive flocculating agent is added 54 to form floccules, preferably with stirring, and then the water is separated from the floccules by for example a filtration press 56 or other suitable filter. Product from the filtration press 56 comprises filter cake and filtrate 68. Pressure is removed from the filter cake before the filter cake is subject to heating 58, for example 1 hour, as illustrated in FIG. 9, then pressure re-applied to form a drier filter cake 60. Post process evaluation may include filtration rate 70 and measurement of moisture content 62 of the filter cake 60 and contact angle 66 of pellet 64, although neither are required in the commercial process. Although use of pressure filtration is preferable, other filter or separation methods may be used. The filtration conditions may be, for example, standing time 30 s, filtration time 300 s, filtration pressure 101 kPa, slurry pH 7.92, solids content 20%, cake thickness 14-15 mm. For drying of the filter cake, it has been found that blowing hot air across or through a disc filter provides lower heating requirements.

FIG. 9 shows an example of the filtration process, including the steps of cake formation 42, cake filtration 44, capillary dewatering 46 and mass transfer dewatering 48.

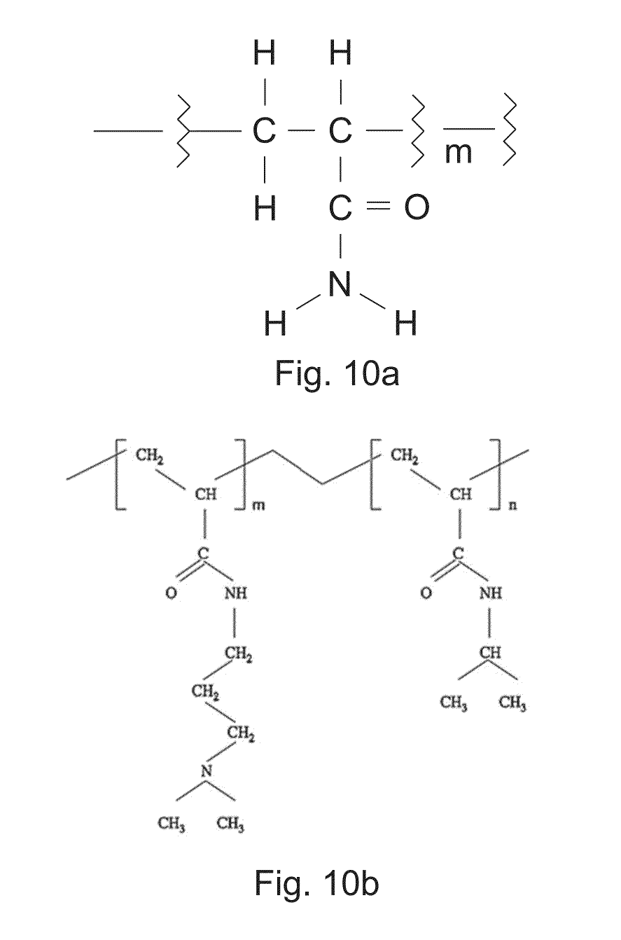

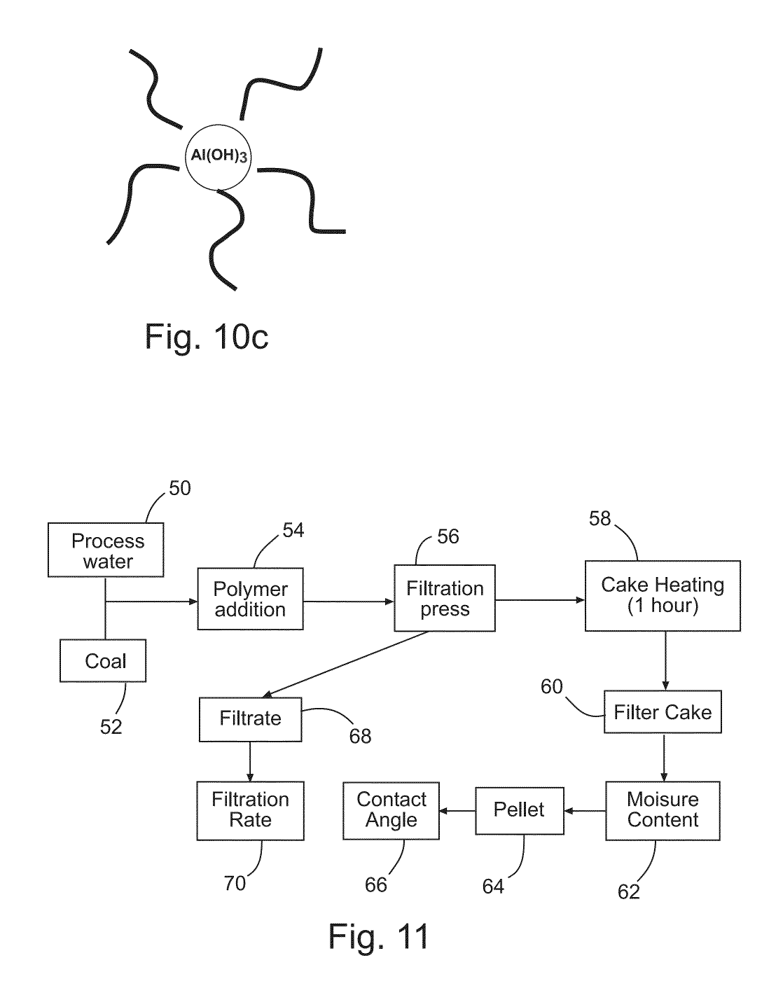

Exemplary temperature sensitive polymers polyacrylamide (PAM) and p[NIPAM-DMAPMA] are illustrated in FIGS. 10(a) and 10(b) and referred to in Table 1 below.

The metal salt complex with temperature sensitive polymer, p[Al-NIPAM-DMAPMA] is illustrated in FIG. 10(c), and referred to in Table 1 below, in which the strands represent the polymer bound to the metal salt.

TABLE 1
Exemplary polymers

| | Polyacrylamide | p[NIPAM- | p[Al-NIPAM- |
|---|---|---|---|
| Polymer | (PAM) | DMAPMA] | DMAPMA] |
| Molecular | 5-6 × 10⁶ | 2.17 × 10⁶ | 1.78 × 10⁶ |
| Weight (Da) | | | |
| Transition | N/A | 37 | 38 |
| Temp (° C.) | | | |
| Notes | | Non-ionic | Colloid ζ- |
| | | | Potential: 21.5 mV |
| Source | Sigma Aldrich | Synthesized | Synthesized |
| | | 5% DMAPMA | 5% DMAPMA |

Other Predicted Chemicals that should work:

Copolymer Changes:

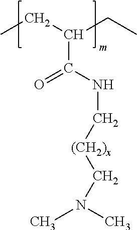

increasing X can produce stronger interactions with coal (at possible expense of solubility).

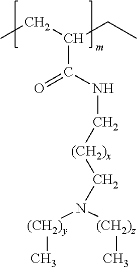

increasing Y or Z can produce a “branched” type structure

Base Polymer variations include:

CH2=C—CON—R2

—R1-R3

As disclosed in U.S. Pat. No. 4,536,294. Changing the chain length of the tsp can aid in solubility.

In the disclosed method, temperature is used for a transition for maximizing water removal of a coal cake. Application of heat is made after a filtration process of the coal slurry. This uses the transition point of the polymer to further drive water out of the floccules. The addition of aluminum colloid or other metal in our study shows the further benefits of producing a polymer with a non-straight (in this case star-like) structure. It is this polymer that shows the highest effectiveness in dewatering coal. Any water soluble metal that creates a water soluble colloid with the polymer may be used, though toxic or dangerous materials should of course be avoided. Metals such as Al, Fe, Ni or Mg may be used. Multivalent metals may be used. The addition of a metal colloid is illustrated by method steps listed below. Care is required to avoid only having the effect of adding the metal ion to solution. The presence of the metal colloid changes the structure of the polymer as well as its charge density. The metal colloid center causes the polymer to bind to it in such a way that a star-like structure is formed around the polymer. This in turn affects the polymer's ability to flocculate particles. The structure is able to bind to many particles around it. The metal colloid is preferably formed within a size range (commensurate to the size of the polymer chains), the zeta potential needs to be sufficiently positive, and proper stirring conditions/addition of chemicals (for example, addition of an 0.1 Ammonium bicarbonate solution to an 0.1 Aluminum Chloride solution at a rate of 0.5 g/min) may be important steps in the formation of the colloids. The preferred size of the metal colloids is about 30-50 nm diameter. The polymer will still form outside this size range (20-200 nm), but will be less effective, possibly due to a difference in polymer structure. Zeta Potential of the colloid preferably needs to be >15-20 mv. Stirring conditions used: 1 inch stir bar at 300 rpm (but other methods of mixing may be used). The process should be operated without contamination by dust. Colloid size changes over time, but is generally stable overnight. It is best to use a prepared colloid solution right away after creation. In the disclosed process of combining the polymer with the metal colloid: Initiator and accelerator must be added dropwise—Nitrogen purge is important. However, other methods may be used for preparation of the colloid. For different metals, different process conditions are required as would be clear to a person of average skill in the art. For example, Fe colloid requires more acidic solution, a slower addition of the precursors, use right away and adjustments in pH. The overall process remains the same (initiator, accelerator, N2 purging). Other forms of metal colloids besides hydroxides can be used. An insoluble metal colloid in water of the appropriate size and charge is sufficient.

The metal colloid with NIPAM and DMAPMA or other temperature sensitive polymers may be used for the settling of other slurries, such as tailings from an oil sands operation.

FIG. 1 shows the ultra-fine coal 10 suspended in water, flocculation of ultra-fine coal with temperature sensitive polymer 12 addition, and dewatered floccule 14 of ultra-fine coal. In the process of polymer addition, the hydrogen bonding between the water molecules and polymer is strong as a result of its hydrophilic nature. However, in the case of temperature sensitive polymer 12 the hydrophilic behavior is transformed to hydrophobic nature by controlling temperature. The unique nature of the temperature sensitive polymers allows them to be effective flocculents. Below their phase transition temperature they exhibit a hydrophilic behavior similar to other polymers, whereas, above the phase transition temperature they become hydrophobic in nature. In the case of above the transition temperature, the hydrogen bonding between the water and polymer is disrupted causing it to shrink into a large compact floccule globule. The significance of temperature sensitive polymers in dewatering ultra-fine coal may be further enhanced by the addition of an inorganic component.

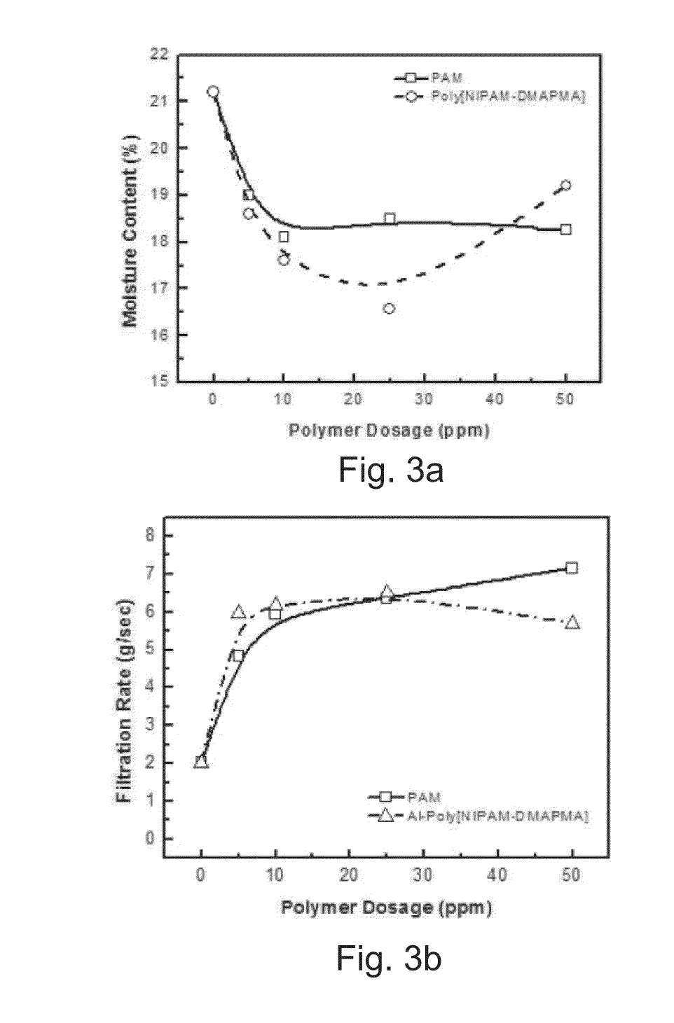

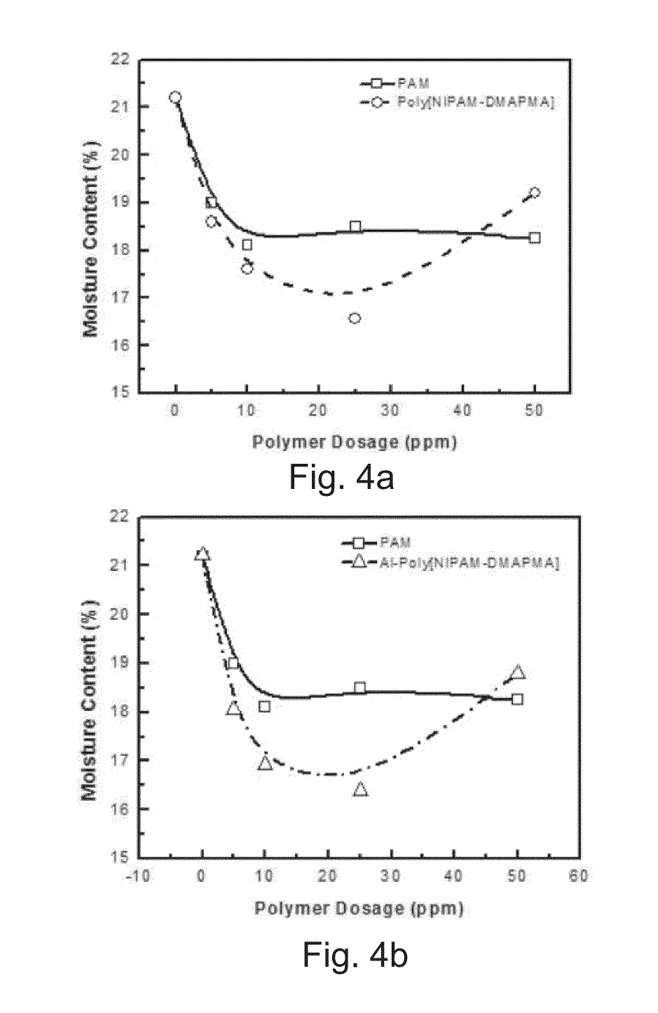

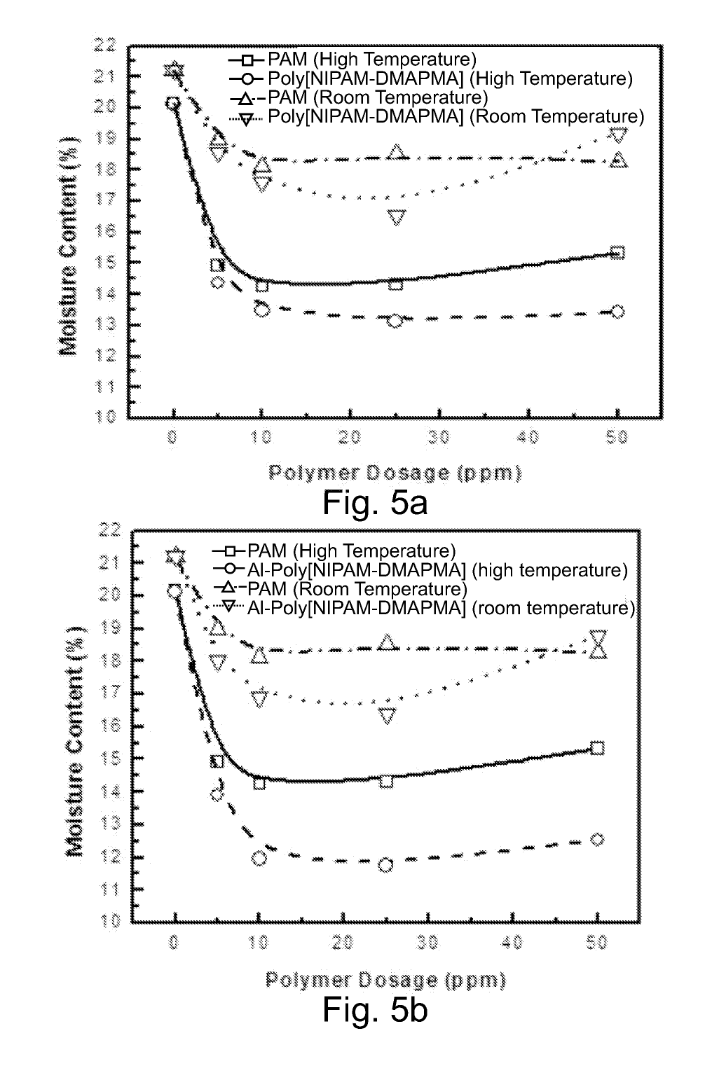

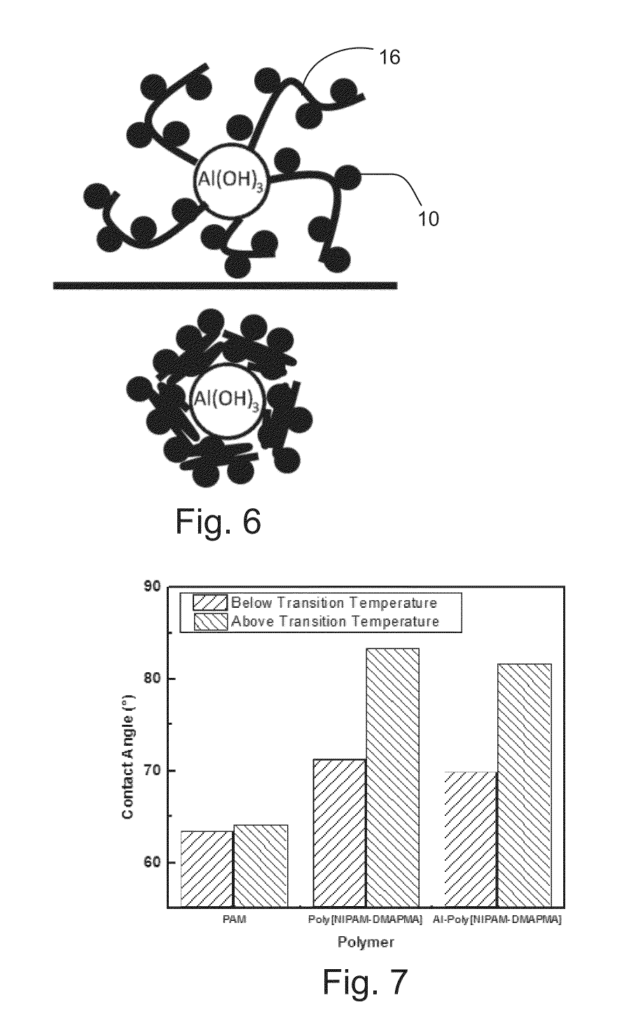

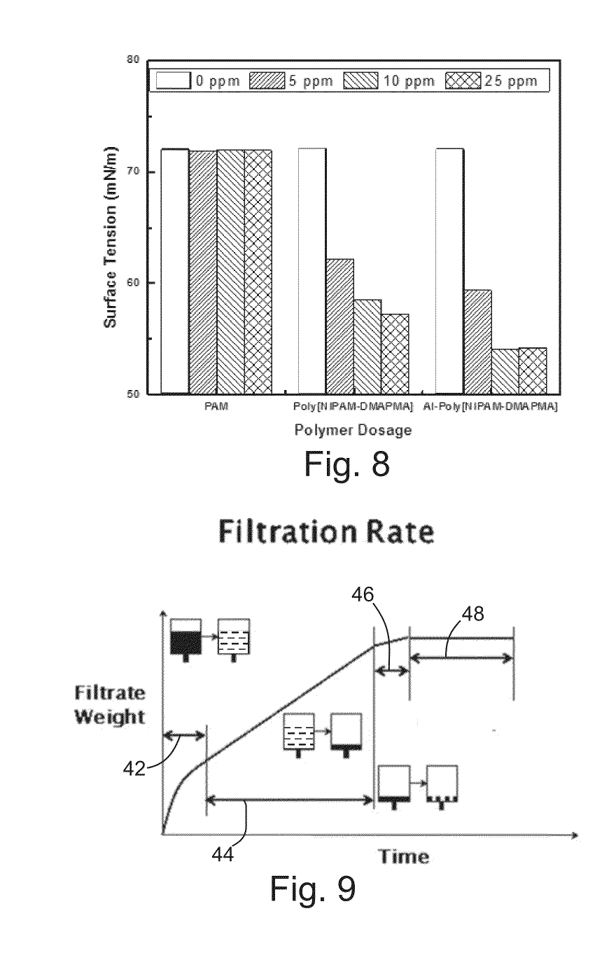

Filtration tests were performed on a bench scale pressure filter (FIG. 2). The filtration press system shown in FIG. 2 comprises a glass body 20, heating element 22, thermocouple 24, Erlenmeyer flask 26, temperature controller 28, support stand 30, metal base 32, funnel 34, balance 36, computer 38, and compressed air from gas cylinder 40. The tests were carried out at room temperature and above transition temperature of the polymer (i.e. 45-50° C.). Dosage levels of the polymers are varied from 0 to 50 ppm, but the effective amount will vary with the application and is easily determinable by experimentation. The test results were compared with the behavior of polyacrylamide (PAM) polymer. The parameters studied in these experiments were filtration rate, moisture content, contact angle, and surface tension. Among the studied parameters, the influence of moisture content plays a significant role in the application of dewatering ultra-fine coal. The current results suggest that the dosage levels below the transition temperature have a substantial impact on the filtration rate for both Poly [NIPAM-DMAPMA] and PAM (FIGS. 3A and 3B). In contrast, both temperature sensitive polymers showed a significant impact on moisture reduction in comparison with PAM. In addition, the relationship between the moisture reduction rate and filtration rate was highly significant for the studied polymers at a lower dosage level of 5 ppm. On the other hand, above the dosage level of 5 ppm the relationship is less significant for temperature sensitive polymers in contrast to a deteriorating trend observed for PAM (FIGS. 4A and 4B). The experiments performed above the transition temperature showed a prominent moisture reduction profile for temperature sensitive polymers due to its phase transition behavior in comparison with PAM (FIGS. 5A and 5B). Further observation confirms that the complex structure of Al-Poly [NIPAM-DMAPMA] 16 (FIG. 6) contributes the highest moisture reduction profile in both studied temperatures. Moreover, the temperature sensitive polymers showed a higher contact angle (FIG. 7) and lower surface tension (FIG. 8) over PAM due to its hydrophobic nature. Therefore, it can be concluded from the study that the temperature sensitive polymers are significant. Among the studied temperature sensitive polymers Al-Poly [NIPAM-DMAPMA] seems to be a feasible and cost-effective option for dewatering ultra-fine coal at lower dosage levels.

Procedures of Making Temperature Switchable Polymers

Preparation of Aluminum Colloids

Prepare a 0.1M AlCl₃ solution in a beaker by dissolving 0.33 g of AlCl₃ in 25 g of water

In a second beaker, prepare a 0.1M (NH₄)₂CO₃ solution by dissolving 0.48 g of (NH₄)₂CO₃ into 50 g of water

Add baffles to the first beaker, add a 1 inch magnetic stirring rod to the first beaker, set a stirring rate of 500 rpm and cover both beakers with Parafilm

Note: The reaction is sensitive to dust

Add (NH₄)₂CO₃ solution to the 25 g of AlCl₃ solution using a mini-pump at a rate of 0.5 g/min.

Note: Calibrate the pump before use and monitor addition using a balance

Stop addition of (NH₄)₂CO₃ when 36 g of the (NH₄)₂CO₃ solution has been added to the AlCl₃ solution.

Measure the colloid size and zeta-potential using ZetaPals. Also measure pH. Continue addition of (NH₄)₂CO₃ if colloid size is too small or zeta-potential is negative.

Note 1: Zeta potential is more important than size in the later reaction

Note 2: Colloid size should be between 30-50 nm

Note 3: pH should be between 5.2 and 6.0

Note 4: Amount of (NH₄)₂CO₃ solution required can vary reaction to reaction.

Note 5: Colloid size can change overnight

Note 6: It is best to use colloid solution in the following reaction right away

Preparation of Poly[NIPAM-DMAPMA]& Al-Poly[NIPAM-DMAPMA]

Measure 50 ml of Mill-Q water for synthesis of Poly[NIPAM-DMAPMA] or 50 ml of Aluminum Colloids (See Above Section for Synthesis of Aluminum Colloids) into a 100 ml Filtering Flask with side arm

Dissolve 4.2864 g of NIPAM and 0.3394 g of DMAPMA into the solution in the reaction flask. Stir the mixture with a 1 inch magnetic stirring rod at a speed of 300 rpm.

Seal the flask and then purge the flask with N₂ for at least 1 hour

Prepare a solution of 10 g/ml Potassium Persulfate (Initiator) and measure 2.3 ml into a syringe

Note: Potassium Persulfate solution will decompose; prepare a fresh solution for each synthesis reaction

Measure 0.045 ml of N′,N′,N′,N′-Tetramethylethylenediamine (Accelerator) into a syringe

Note: Blow the stock bottle with nitrogen gas, exposure to oxygen will decrease the effectiveness of the accelerator

Add the initiator and accelerator to the flask to initiate the reaction (Keep nitrogen flow running)

Note: An increase in viscosity should be observed within 10 minutes of initiating the reaction

Shut off the nitrogen flow after two hours.

Purification of Poly[NIPAM-DMAPMA]& Al-Poly[NIPAM-DMAPMA]

Dilute the polymer gel with Milli-Q water and stir the solution for a few hours so that a homogeneous solution is formed

Transfer the resulting solution to a larger and heat the polymer solution to approximately 60° C.

Remove the large solid chunks of polymer from the beaker using a glass stir rod

Note: Large chunks of polymer should form on the sides of the beaker

Filtrate the remaining solution using a heated filtration set

Note: Temperature must remain above the polymer transition temperature

Place the polymer onto a Teflon plate and dry the polymer in a vacuum oven at 60° C. overnight

APPENDIX—EXCERPTS FROM U.S. Pat. No. 4,536,294, except “present invention” is changed to “disclosure of U.S. Pat. No. 4,536,294”. The materials disclosed in U.S. Pat. No. 4,536,294 may be used as the disclosed temperature sensitive polymer but the invention is not limited to those polymers.

The preferred polymers useful in the disclosure of U.S. Pat. No. 4,536,294 are polymers of compounds which correspond to the general formula:

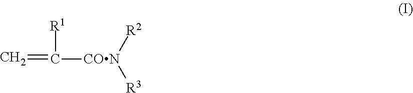

in which R.sup.1 represents hydrogen or methyl;

R.sup.2 and R.sup.3 represent groups independently selected from hydrogen and C.sub.1-C.sub.6 straight or branched chain alkyl, with the proviso that both R.sup.2 and R.sup.3 are not hydrogen.

Most preferred are those in which one of R.sup.1 and R.sup.2 is methyl, isopropyl, propyl, n-butyl, s-butyl or t-butyl.

The polymers used in the above invention should preferably exhibit a CFT or critical solution temperature CST in the 0.degree.-80.degree. C. approximate range. Of the polymers of monomers of formula I given above, in some cases high molecular weight homopolymers will exhibit a suitable CST. In other cases it is necessary to copolymerise them in suitable amounts with other copolymerizable monomers to obtain high molecular weight polymers of suitable CFT and CST. For example, homopolymers of N-isopropyl-acrylamide (NIPAM) exhibit a suitable CFT. Its CFT can however be adjusted by copolymerization with different amounts of a copolymerizable monomer, the water solubility of the homopolymer of which is different from that of poly NIPAM, such as acrylamide. On the other hand, homopolymers of N-methylmethacrylamide (NMMA) are water soluble throughout the range 0.degree.-100.degree. C. so that NMMA should be copolymerized with the appropriate amounts of a comonomer which yields water insoluble polymers e.g. acrylonitrile, to obtain high molecular weight copolymers exhibiting a suitable CFT. Conversely, monomers of formula I where one or both of R.sup.2 and R.sup.3 is alkyl C.sub.4 or higher will yield homopolymers insoluble in water at all temperatures from 0.degree.-100.degree. C., and so they should be copolymerized with monomers which yield water soluble polymers such as acrylamide.

(portion of U.S. Pat. No. 4,536,294 omitted)

The critical flocculation temperature (CFT) of the flocculant can be adjusted so that the flocculant operates to settle fines at a lower temperature in settling tanks and ponds, but does not cause premature flocculation in a process which is run at a higher temperature, and in which recycle water containing minor amounts of flocculant is warmed and fed back to the processing operations.

(portion of U.S. Pat. No. 4,536,294 omitted)

Preferred polymers for use in the disclosure of U.S. Pat. No. 4,536,294 . . . have a CFT below about 70.degree. C., preferably in the range from about 20.degree. C. to about 70.degree. C. and most preferably in the approximate range of 30.degree. C.-50.degree. C., such temperatures being below those at which the oil sands separation process is conducted. The CFT of a given polymer is determined, inter alia, by its composition and molecular weight. Within the scope of the disclosure of U.S. Pat. No. 4,536,294, polymers and copolymers of NIPAM can be devised having a wide range of appropriate critical flocculation temperatures.

The preferred polymers used as flocculants in the process of the disclosure of U.S. Pat. No. 4,536,294 are homo-and copolymers of NIPAM with a high molecular weight. The molecular weight is most suitably at least 1.times.10.sup.6 g/mol, to ensure an efficient flocculation and to demonstrate the CFT, and most preferably in the range of 1-200.times.10.sup.6 g/mol, although lower molecular weights, e.g. down to 0.5.times.10.sup.6 may be required for other specific applications. These Figures correspond to viscosity average molecular weights and are calculated from the limiting viscosity number determined on the polymer. The method of polymerization for making these polymers, in the suitable molecular weight range, is dependent upon the desired polymer flocculant. The homo-polymer of N-isopropylacrylamide, poly(N-isopropylacrylamide), poly(NIPAM), may be polymerized to a suitably high molecular weight, by free radical polymerization in aqueous medium using a persulphate/bisulphite initiator or other water soluble free radical catalyst.

Numerous copolymers of NIPAM have been found to be effective and efficient in the flocculation of suspensions of the nature described herein. These copolymers should contain at least 50% NIPAM polymerized units and can be polymerized to a suitably high molecular weight by using one or more of anionic, cationic or free radical polymerization methods. The initiators and appropriate reaction conditions of these polymerization techniques are within the skill of the art. The following are examples of useful potential comonomers, but in no way comprises an exhaustive list. The comonomers are listed corresponding to the type required to achieve efficient flocculating properties:

Anionic flocculants, made by copolymerization of NIPAM with: acrylic acid, sodium acrylate, methacrylic acid, acrylic acid acrylamide;

Cationic flocculants, made by copolymerization of NIPAM with: dimethylaminopropyl methacrylamide (DMAPMA), methacrylamidopropyltrimethylammonium chloride (MAPTAC), 2-hydroxy-3-methacryloxypropyltrimethyl ammonium chloride, methacrylamido-hydroxypropyltrimethylammonium chloride (G-MAC), vinyl pyridine;

Non-ionic flocculants, made by copolymerization of NIPAM with: acrylamide, methacrylamide, N,N-dimethylacrylamide,N-methylol acrylamide, hydroxypropyl N-vinylpyrrolidine, diacetone-acrylamide, 2-hydroxypropylmethacrylate, 2-hydroxyisopropylacrylamide, acrylonitrile, methacrylonitrile, styrene, alkyl methacrylates, and combinations thereof.

Flocculation and an increased settling rate may also be brought about by using two or more of the above described polymers in combination, the requisite amounts of which may be determined by routine experimental testing. The type of flocculant used, whether a single polymer or a combination of polymers will determine the nature of the resulting floc.

Homogeneous flocculation of clay and sand can be effected by use of non-ionic polymers and copolymers of NIPAM containing at least 50% NIPAM units on a molar basis. Such polymers flocculate the heavier suspended clay particles to give a very rapid flocculation and settling thereof with the sand components. Other types of polymer flocculants used in the disclosure of U.S. Pat. No. 4,536,294 appear more readily to flocculate the finer suspended clay particles, with the result that they cause a more thorough flocculation over time, giving maximum solids content in the deposited layers and minimum residual solids content in the remaining liquid, but over a relatively longer period of time.

Specific examples of polymers which will give homogeneous floc formation are homopolymeric NIPAM and copolymers of NIPAM containing not more than 50 mole percent acrylamide.

Suitable amounts of polymeric flocculant used in the disclosure of U.S. Pat. No. 4,536,294 are up to 600 ppm, based on the weight of the aqueous suspension to be treated. Preferred amounts are from 50-400 ppm. Higher amounts, although effective, are uneconomic in practice.

This ends the selected disclosure from U.S. Pat. No. 4,536,294. Other temperature sensitive flocculating agents may be used.

What is claimed is:

1. A flocculating agent that comprises a complex of a metal salt and multiple strands of a temperature sensitive polymer that has a critical temperature below which the temperature sensitive polymer is a flocculent and above which the temperature sensitive polymer is hydrophobic.

2. The flocculating agent of claim 1 in which the temperature sensitive polymer comprises NIPAM.

3. The flocculating agent of claim 1 in which metal in the metal salt is aluminum.

4. The flocculating agent of claim 1 used for the purpose of flocculating coal fines.

5. A process for separating fines from an aqueous liquid using a temperature sensitive flocculating agent and which has a critical flocculation temperature, said critical flocculation temperature being the temperature below which the temperature sensitive flocculating agent exhibits flocculating ability and is hydrophilic and above which the temperature sensitive flocculating agent is hydrophobic, which comprises adding to the aqueous liquid an effective amount of the temperature sensitive flocculating agent at a temperature below the critical flocculation temperature of the flocculent to cause generation of floccules, separating floccules from the aqueous liquid, then heating the floccules to a temperature above the critical flocculation temperature of the temperature sensitive flocculating agent to expel water from the floccules to create solids and expelled water.

6. The process of claim 5 in which the temperature sensitive flocculating agent comprising at least a metal complex including a metal salt and a water soluble polymer that has a temperature sensitive hydrosensitivity.

7. The process of claim 5 in which the temperature sensitive flocculating agent has a molecular weight at least 0.5×10⁶ g/mol.

8. The process of claim 5 in which the fines are coal fines.

9. The process of claim 5—in which separating floccules comprises filtration.

10. The process of claim 9 in which filtration comprises pressure filtration.

11. The flocculating agent of claim 2 in which metal in the metal salt is aluminum.

12. The flocculating agent of claim 2 used for the purpose of flocculating coal fines.

13. The flocculating agent of claim 3 used for the purpose of flocculating coal fines.

14. The process of claim 6 in which the temperature sensitive flocculating agent has a molecular weight at least 0.5×10⁶ g/mol.

15. The process of claim 6 in which the fines are coal fines.

16. The process of claim 7 in which the fines are coal fines.

17. The process of claim 6 in which separating floccules comprises filtration.

18. The process of claim 7 in which separating floccules comprises filtration.

19. The process of claim 8 in which separating floccules comprises filtration.
